(19) United States
(12) Patent Application Publication
(10) Pub. No.: US 2004/0230416 A1
(43) Pub. Date: Nov. 18, 2004

(54) Bifurcated operating system having a language neutral component

(75) Inventors: Shenghua Ye, Sammamish, WA (US); Wei Wu, Kirkland, WA (US); Frank N. Chu, Issaquah, WA (US); Mohammed G. El-Gammal, Woodinville, WA (US); Julie D. Bennett, Medina, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/435,848

(22) Filed: May 12, 2003

(51) Int. Cl. G06F 17/28; G06F 17/20

(52) U.S. Cl. 704/5; 704/8

(57) ABSTRACT

An improved operating system architecture comprises a bifurcated structure having a substantially language neutral, non-localizable portion as well as one or more localizable portions. This bifurcated structure allows for easier distribution, updating, and patching of the operating system. Methods of producing the bifurcated operating system can be applied before or after compiling of the source code. If applied prior to compiling, tags may be used to aid in bifurcation. One or more control files provide a further mechanism for influencing the destination of components in the bifurcated structure.

### FIELD OF THE INVENTION

This invention relates generally to computer applications and operating systems and, more particularly, relates to a system and method for making and using an application or operating system that has functional code and language-neutral data stored separately from localizable User Interface (UI) resources.

### BACKGROUND

Most multi-purpose computers and computing devices have operating systems, i.e. control programs that run the computer. The operating system is typically the first program that is loaded at the time that the computer is powered on. Portions of the operating system such as the kernel may remain in memory continually while the computer is on. Programs running on the computer do so by interfacing to the operating system, such as via application programming interfaces (APIs). The operating system typically fulfills a number of specific functions including providing a basic user interface through which a user can access the computer. User interfaces may be command-line-based such as in DOS and UNIX, or may be menu-driven or graphical. Some operating systems allow a user to choose the type of interface to use. Other roles filled by the operating system include job management (controlling the running of programs, such as the order, priority, etc. of running), task management (e.g. controlling the running of jobs), data management (tracking the data of the computer, such as location of data on the disk), device management (i.e. controlling data input and output with respect to peripheral devices), and security.

As computers have become more prevalent around the world, the need for different versions of one operating system or application optimized or localized for different languages and/or locales has increased, as have the overhead costs associated with producing, updating and maintaining such diverse versions. An operating system typically comprises code, data, and language-specific UI resources together in a single binary entity, such that modification of any part of any portion requires an update to the whole. Thus, an update, such as pursuant to a security patch, must be processed with respect to the code portion of the operating system or patch, after which the code portion is again combined with the data and resources and a single binary produced that differs from the original binary.

Moreover, this process must be repeated for each language of interest. This process is referred to as “localization,” with each resultant version being referred to as a “localized” version. Since, in the majority of cases when a change is required, the change occurs in the code portion and not the language specific portions, it is wasteful and costly to produce separate localized versions of most fixes, updates, etc. Moreover, when a rapid update response is necessary, such as in issuing a security fix, the delay caused by the need to produce many different specifically localized versions of the fix can leave users unprotected for an unacceptable period of time. Often in such situations, users in low priority locales bear the brunt of the delay since localized versions for higher priority locales are typically produced first.

Moreover, for users or organizations that use multiple computers employing diverse respective languages, such as a multi-national corporation, the time and overhead expended in applying a received fix that has separate localized versions is often high, since the appropriate fix version must be selected and applied for each computer. Thus, both the producer and the consumer experience unnecessary waste and delay when using multiple specifically localized versions, each comprising a single binary.

### BRIEF SUMMARY OF THE INVENTION

Embodiments of the invention allow for the production of an operating system and “fixes” thereto (e.g. patches and updates distributed after the release of the operating system) having a language neutral binary portion relating to the code and non-localizable data portion of the operating system and a language specific binary portion of the operating system related to the localizable resources used by or made available by the operating system. Some types of fixes are referred to as “Service Packs” or “hot fixes.” Language specific resources include such things as most user interface elements, especially those containing words or characters, as well as system documents such as help files. By separating the language neutral portion from the language specific portion, the non-localizable code/data portion of the operating system and the localizable resource portion of the operating system can each be modified and updated independently of the other.

In an embodiment, a code build process is provided for producing separate language specific and language neutral binaries as separate portions of an operating system. The process minimizes the alterations needed in current code development and finishing processes to supply an operating system comprising separate language specific and language neutral binaries.

In a further embodiment, a manifest is adapted to provide resource location services so that code that utilizes resources can locate the appropriate resources. In addition, a control file is usable to record decisions as to which resources may be localized and which may not. For example, a particular bitmap may be non-localized, i.e. used in all languages, while other resources may be used in only one or a small number of languages. The resource loading is adapted to utilize the manifest when locating and loading resources in an embodiment of the invention.

In a further embodiment, a compiler such as the Windows Resource Compiler (RC.EXE) by Microsoft of Redmond, Wash., is updated to read manifest information and to compile language neutral resources and language specific resources accordingly into separate resource files, e.g. .res files. In this manner, a linker can then link the language neutral resources and language specific resources into separate PE binaries, one for language neutral data and functional code and another for localizable resources.

Although the description herein focuses primarily on the creation and use of a bifurcated operating system, it will be appreciated that many of the principles and benefits of bifurcation described herein apply as well to applications that are not operating systems. Thus, in further embodiments of the invention, a bifurcated application having a substantially language neutral portion and a localizable portion is contemplated.

In an embodiment, applications running on the operating system will not be affected by the split nature of the operating system, and in particular are adapted to locate needed resources via the manifest. Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary device architecture in which embodiments of the present invention may be implemented;

FIG. 2 is an architectural diagram illustrating an existing operating system binary having a code portion and a resource portion in a single binary;

FIG. 3 is an architectural diagram illustrating an existing operating system binary having a code portion and a resource portion in a single language specific binary as well as additional localization resources;

FIG. 4 is an architectural diagram illustrating an operating system configuration according to an embodiment of the invention wherein the operating system has a language neutral code binary portion and a language dependent resource portion in separate binaries;

FIG. 5 is a flow chart illustrating steps taken according to an embodiment of the invention to create an operating system having a language neutral code binary portion and a language dependent resource portion in a separate binary;

FIG. 6 is a flow chart illustrating steps taken according to an alternative embodiment of the invention to create an operating system having a language neutral code binary portion and a language dependent resource portion in a separate binary; and

FIG. 7 is a flow chart illustrating steps taken according to an embodiment of the invention to localize an operating system for release in different locations and or to customers using different languages.

### DETAILED DESCRIPTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

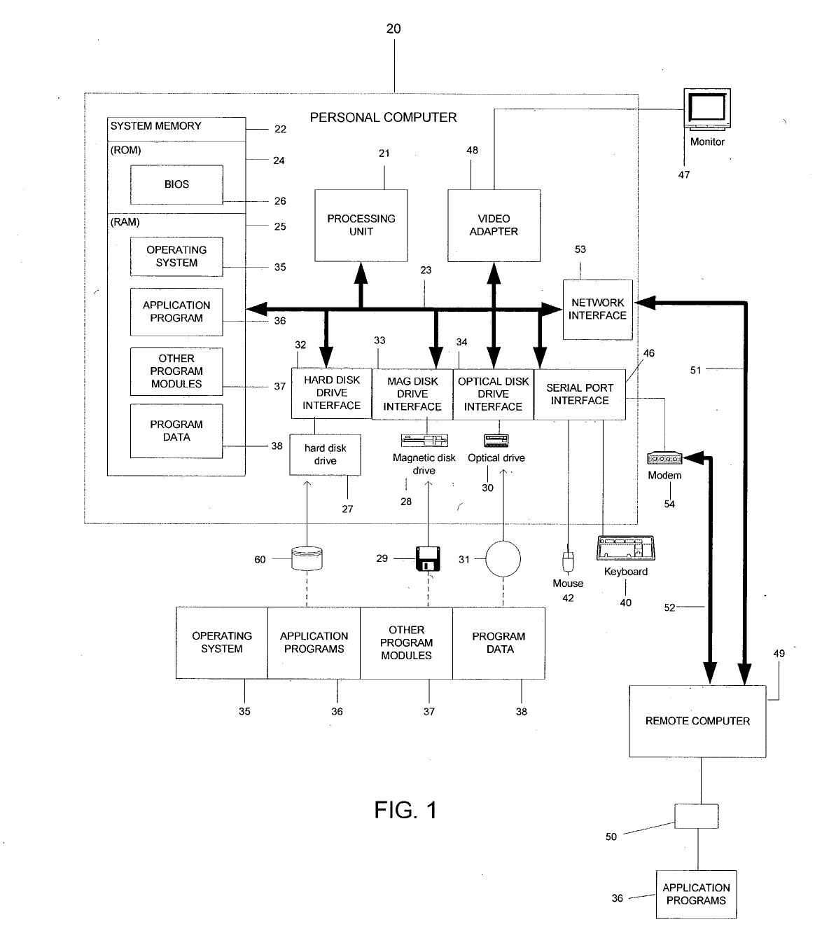

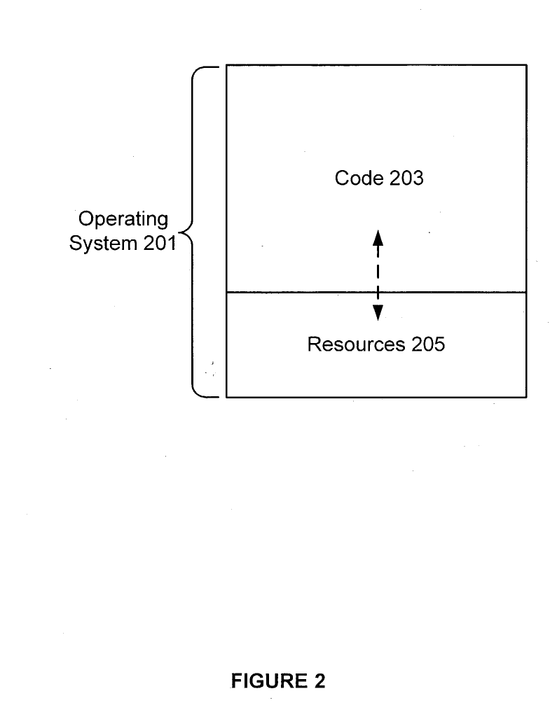

This description begins with a description of a general-purpose computing device that may be used in an exemplary system for implementing the invention, after which the invention will be described in greater detail with reference to FIG. 2 and subsequent Figures. Turning now to FIG. 1, a general purpose computing device is shown in the form of a conventional personal computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. Program modules depicted relative to the personal computer 20, or portions thereof, may be stored in the remote memory storage device if such is present. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various acts and operations described hereinafter may also be implemented in hardware. Moreover, it will be appreciated that although the description herein focuses primarily on the creation and use of a bifurcated operating system, the bifurcation described herein applies as well to applications.

Turning to FIG. 2, an architectural diagram is shown, illustrating an example existing operating system. In particular, the illustrated operating system 201 is a mixed single binary comprising code portions 203 and resource portions 205. Such a traditional architecture results in difficulty during an update to either the code portions 203 or the resource portions 205. In particular, the code portions 203 are generally language neutral while the resource portions 205 are generally largely language specific. Most updates after release of an operating system relate to fixes and patches of the code portions 203 of the operating system rather than the resource portions 205. Thus, while both the code portions 203 and the resource portions 205 may be altered substantially prior to release, they are changed at significantly different respective frequencies after release.

However, in the example prior architecture, a change to the code portions 203 necessitated changes and reinstallation related to both the code portions 203 and the resource portions 205 in the following manner. First, the appropriate changes to the source code underlying the code portions are made. Next, the new source code and the old resources are combined to generate a new single binary embodying the desired fix. Note that for each language specific version of the resources, a new binary file must be created in this manner. Next, the localized binaries are distributed to the appropriate respective locales. For companies or entities using multiple languages, multiple separate binaries would typically be obtained at this stage. Finally, the updated binaries are installed on the machines (such as personal computer 20 above or other computing device) that require the fix. In locations using multiple languages, an appropriate language fix must be installed for each machine.

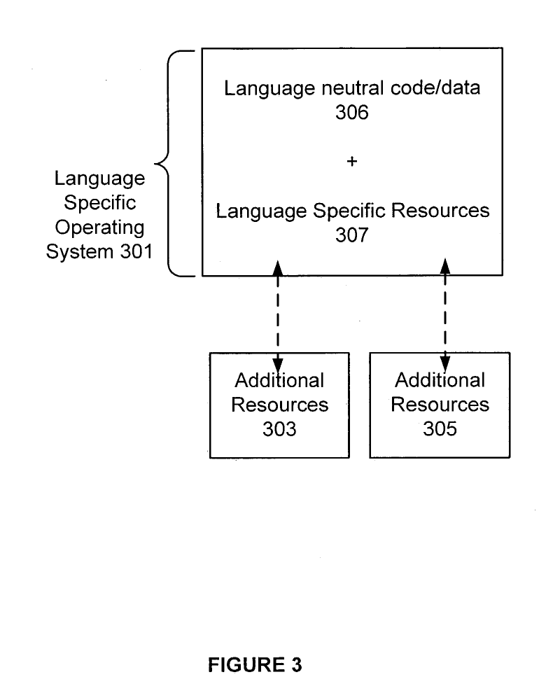

FIG. 3 shows another example prior architecture. In particular, the architecture comprises a language specific operating system 301 as well as possibly other language specific resource modules 303, 305. The language specific operating system 301 contains language neutral code and data 306 as well as language specific resources 307 in a particular language, such as English. The resource modules 303, 305 are each adapted for a language of interest and typically do not contain all relevant UI resources in the language of interest, but do contain a portion thereof, such as most of the traditional Win32 resources. The appropriate resource modules 303, 305 are installed, and the operating system is directed, such as by configuration or user selection which module 303, 305 to use.

However, this technique does not eliminate the language dependence in the operating system. Including English resources in the operating system 301 increases the system size for other language users considerably and can increase the manufacturing cost for embedded systems, where the OS is stored in ROM. This model also does not allow localized resource data 303, 305 to be serviced independently from the code portion embedded within operating system 301. With respect to development of an operating system product, this model treats English differently from other languages and requires the rest of the languages to be handled in a different manner with respect to the setup process, code execution, and testing process.

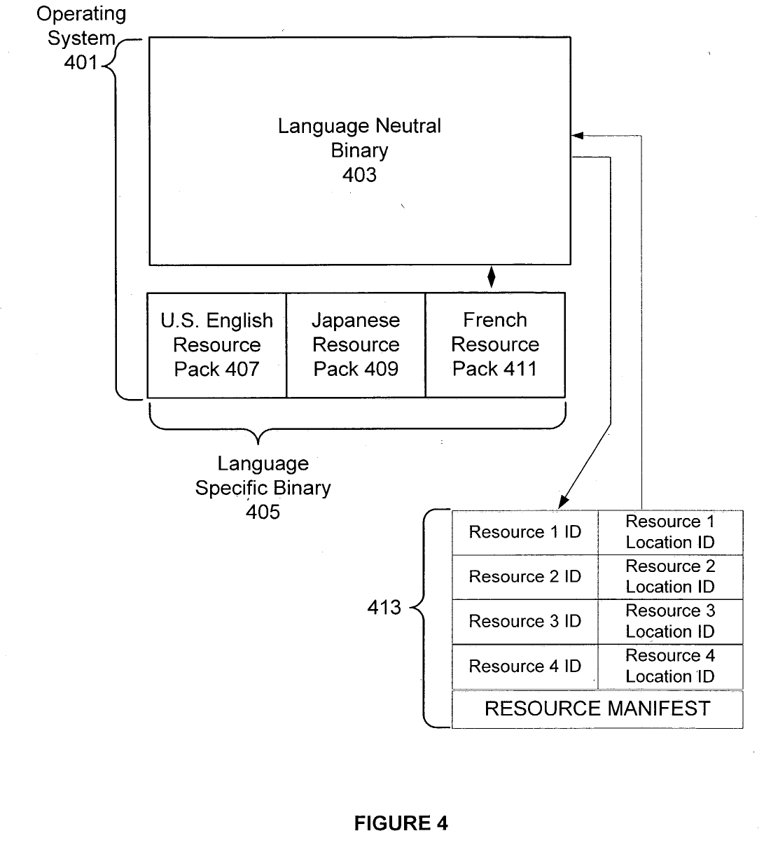

Referring now to FIG. 4, a bifurcated operating system architecture according to an embodiment of the invention is shown. In particular, an operating system 401 is shown comprising two separate binaries, a language neutral binary 403 comprising code and language neutral data, and a localized or language specific binary 405. The language neutral binary 403 comprises material that is not localizable, e.g. material that does not need to be translated from one language version of the system to the next. The language specific binary 405 comprises material that is localized, i.e. it is adapted for display in a particular language. Non-exhaustive examples of typically localizable materials include UI text and graphics, as well as currency and customary symbols and notations.

In the illustrated example, the language specific binary 405 is shown comprising multiple resource packs 407, 409, 411 corresponding to U.S. English (407), Japanese (409), and French (411), which is in accordance with an embodiment of the invention, although more typically only a single resource pack will be provided with the operating system in embodiments of the invention, the provided resource pack being matched to the language of the user or purchaser or otherwise selected. It will be appreciated that the specific resource packs illustrated (English, Japanese, and French), are exemplary only, and a resource pack may be provided in any language of interest beyond those specifically shown in FIG. 4. Note that the separation illustrated between localizable and non-localizable resources is preferably embodied not only in system PE binaries (DLL, EXE, OCX, SYS, etc.), but also in any data or other forms of binaries, e.g. XML data, or Html data.

When installed, the architecture of FIG. 4 includes, according to an embodiment of the invention, a manifest or other record 413 that facilitates location of the appropriate resources by the operating system. In particular, the manifest allows localization by mapping an identifier of a resource to be retrieved to a location of the resource in the appropriate resource pack. For example, the machine on which the operating system resides may be used by a Japanese user, and may thus have a Japanese resource pack. Preferably, a system setting indicates which resource pack is to be utilized if multiple ones are present. When a resource, such as a help file, is to be retrieved, an instantiation of the code portion 403 of the operating system 401 calls code controlling the manifest 413 with an identifier associated with the desired help file. The code controlling the manifest may either forward the call after locating the resource or may instead return an indication of the location to the calling entity.

There are a number of scenarios in which this new operating system model is useful. Several primary use scenarios are discussed briefly hereafter, although this discussion is not intended to be exhaustive and other scenarios exist wherein such a system is of use. In a first scenario, a user understands only his or her own language and is not concerned with a multi-lingual interface. This type of user typically desires to see an interface that is the same as a specifically dedicated localized version and to experience similar performance. Accordingly, for such users, it is desirable that language settings are hidden and that there is no language specific aspect to setup. For such users, it is preferable that the setup of the operating system with respect to language selection is automatic. To this end, if in the installation resources on CD (or in machine memory, etc.) only a single language resource pack is included, then the set-up process should not present a language selection step but instead should automatically select the language according to the resource pack that is present. If instead multiple resource packs are present, such as when the operating system is shipped to European countries, then preferably, the installation process exposes a language selection screen with the prompt listed in each language for which a resource pack is present. After selection, automatic or otherwise, the installation process as well as the operating system should use the selected language for all user interface elements. For users in this scenario, extra language options, such as to display certain user interface elements in a different language, in multiple languages, etc. should be available if appropriate through a menu or otherwise, but preferably are not automatically exposed by default. The default display of such options would likely be a distraction or annoyance to many users.

In another scenario, a user desires to use a primary language most of the time, but would like to occasionally use another language for display or editing. Such users will typically be bilingual, utilizing both a preferred language, such as their native language, as well as another language. This mode of usage would be common for Internet users and others exposed to information from international sources. To support this type of usage, it is preferred that the installation tool exposes an option for the user to add other languages for such secondary use. The mechanism for allowing this election is simply a list of languages associated with checkboxes exposed during installation in an embodiment of the invention so that the user may indicate which alternate language if any is to be used in certain instances.

Various elements of a resource pack, such as fonts, dictionaries, etc. can require a great deal of space for storage in the memory of the computer. Thus, in order to accommodate machines with limited memory, it is preferable that the operating system exposes an easy way for a user to delete resource packs from the computer's memory. This mechanism may consist of an icon on the desktop, a removal option available via a setup menu, etc.

In another scenario, multiple users using various languages log into a single computer. This type of situation would be common for example, at research institutions, universities, libraries, multi-lingual corporations, etc. To support this type of use, it is preferable that the user interface language setting is based on the user identity, such as can be gleaned from a log in screen, with each user being mapped to their desired language and this mapping used automatically at log in to adjust the user interface. In a variation of this scenario, the users can be logged in contemporaneously with one another in a single terminal server system. In this case, as in the prior case, it is preferable that language specific settings are user-based and not machine-based. Moreover, the operating system should support the simultaneous provision of multiple resource packs. To this end, the system preferably loads the language neutral binary as well as each required resource pack. In a server-client system, the language of the information sent by the server is selected based on the identity of the client or the user of the client according to an embodiment of the invention.

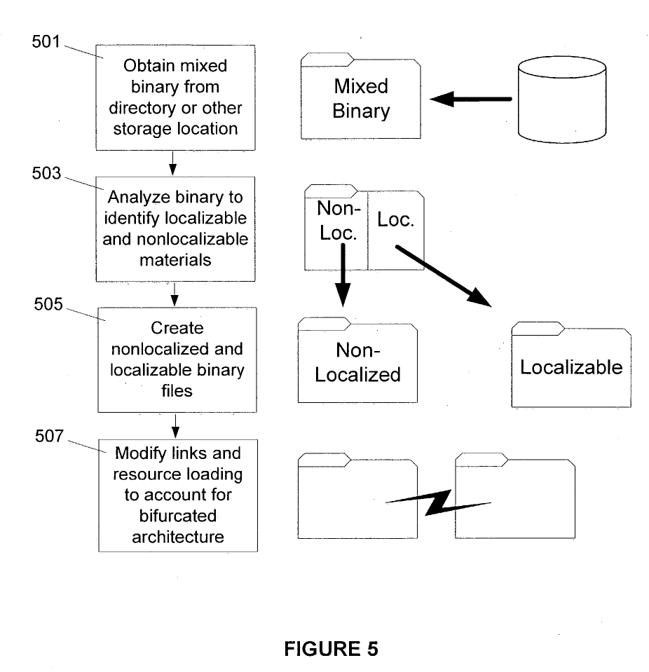

Turning to FIG. 5, a flow chart is shown corresponding to the steps taken to produce an operating system according to an embodiment of the invention, starting from one or more ordinary compiled and linked mixed binaries. This process is most useful when it is necessary to create dual binaries from original mixed binaries, such as a legacy operating system produced with no special knowledge of or accommodation for the technique described herein for separating data and code from resources. Although the following flow chart focuses on the processing of binaries, it should be noted that the process may be performed during compilation and linking as will be discussed later. Initially at step 501, the process obtains the mixed binaries, such as from a directory or other storage location. Examples of such mixed binaries include Win32 executables such as EXE, DLL, SYS, OCX, and so on. At step 503, the process analyzes the binaries to identify localizable material and non-localizable material (typically, but not exclusively, translatable resources). The decision as to whether material is localizable or not can depend upon a number of factors. For example, in an embodiment of the invention, any translatable string or resource that may be displayed via the user interface is considered localizable. In a further embodiment, certain types of language independent materials are nonetheless considered to be localizable. For example, local drivers may be considered to be localizable. In another embodiment of the invention, an exclusion capability is provided, such as via a control file, whereby materials listed in the control file that would otherwise be treated as localizable are instead treated as non-localizable.

At step 505, two separate binary files are created, the first of which is non-localized and will remain the same for all languages, and the second of which is localizable and whose resources correspond to a particular language. For example, the language of resources in this second file will be the language used by the developer when creating the original mixed binary. Finally, at step 507, certain portions of the system are modified to allow the bifurcated system to function properly. Such modifications include altering the setup process to install the additional localizable binaries and altering the system resource loader to load the resources from the new resource binaries without necessitating modification of each component's resource loading code.

Although splitting pre-existing mixed binary files into localizable and non-localizable binaries is necessary and helpful in some instances as discussed above, it may sometimes be preferable to separate the material before compilation so that a mixed binary is not created in the first instance. This approach requires that the compilation and linking process be configured to account for the split architecture according to the invention as will be appreciated from the teachings herein. However, there are a number of benefits conferred by this approach. For example, it allows the developers to handle fewer types of files, and can also allow tagging of localizable and/or non-localizable materials, and thus can facilitate separation of localizable resources with greater precision and granularity.

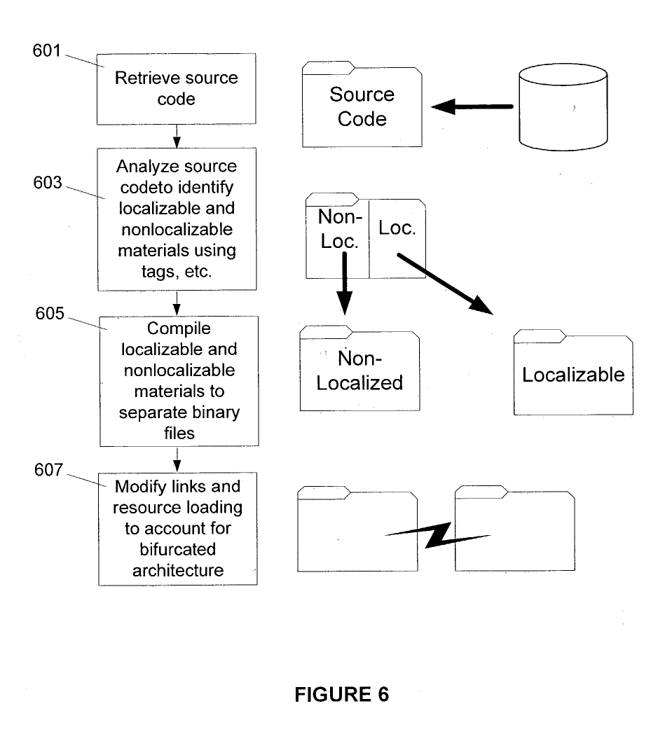

Referring to FIG. 6, a flow chart is shown illustrating a process according to an embodiment of the invention for creating separate localizable and non-localizable binaries from mixed source code. At step 601, the process obtains the source code of interest from a directory or other storage location. Typically a human, such as a developer, initiates the processing of source code into binary form, such as by indicating which file holds the source code to be processed and by indicating the location of the file.

From step 601, the process moves to step 603, whereat the source code is analyzed to identify localizable material and non-localizable material. The distinction between localizable material and non-localizable material can be the same as discussed above with respect to FIG. 5. For example, the decision as to whether material is localizable or not can depend upon a number of factors, including for example whether the material is translatable material for presentation to the user, whether the material is a local driver or other language independent entity that is to be treated as localizable, whether the material is listed in a control file for inclusion or exclusion, etc.

In addition, in the embodiment shown in FIG. 6 where the separation of non-localizable code, data, etc. from localizable resources occurs prior to generation of the binary, it is possible for a code developer to proactively tag material in the source code to aid in properly separating localizable from non-localizable materials during processing. Although it is certainly possible for the developer to tag all material in the source code either as localizable or as non-localizable as appropriate, this approach introduces a great deal of extra work into the code development process. Rather, it is preferable that the developer tag only a subset of the materials in the source code. In particular, the developer may tag some or all localizable materials to aid in the identification of such materials during compilation and linking. Alternatively, the developer may tag some or all non-localizable material.

The tagging of materials as localizable or non-localizable need not correspond to the classification of the material that would result in the absence of tagging. For example, a translatable resource may be tagged as non-localizable, and this would have the same effect as identifying the material in a control file that identifies otherwise localizable resources to be treated as non-localizable. An example of translatable material that may be treated as non-localizable is the UI information that is presented during a system crash, sometimes known as the “blue screen” information. Likewise, materials such as code or data that are not language specific, and that would thus typically be identified as non-localizable, may be treated as localizable via tagging or via a control file or other inclusion and/or exclusion listing. One example of such material is a local driver, as discussed above.

The tagging may be accomplished in any number of ways, and with any level of granularity desired, however, in an embodiment of the invention, the tagging occurs at the component level. Thus for example, a variable in the component source code may be set to create a tag. In one embodiment of the invention, a “language neutrality” variable such as LANGUAGE_NEUTRAL is set equal to 1 to indicate that the component is localizable, and to 0 to indicate that the component is non-localizable. Tagging may also occur at a higher or lower level of granularity. However, if tagging is allowed at multiple levels, a conflict resolution convention is useful in resolving conflicting tags for the same material. In an embodiment of the invention, the convention for resolving a conflict between tags gives priority to the tag at the coarsest level of granularity. Thus if a component is tagged as localizable but the component is part of a larger entity, such as a body of source code comprising multiple components, that is tagged as non-localizable, then everything within the larger entity, including the tagged component, is treated as non-localizable. In a further embodiment, code developers use a source manifest to implement the tagging. That is, in this further embodiment, material listed on the source manifest is treated as being tagged.

Due to the effects of tagging and forced inclusion and/or exclusion, the non-localizable materials may include language-specific or language non-neutral elements. However the extent of inclusion of language-specific or language non-neutral elements in the non-localizable portion of the operating system is substantially less than the extent of inclusion of such elements in the localizable portion of the operating system. As such, the non-localizable portion of the operating system may be sometimes referred to herein as being substantially, if not completely, language neutral. As with a completely language neutral operating system portion, a substantially language neutral operating system portion is one that must be combined with a language non-neutral portion to form a functioning operating system for any target language. For example, the English version of the operating system would comprise two components (a language specific portion, or resource pack, and a substantially language neutral portion, e.g. the non-localized binary) in the same manner as any other language version of the operating system.

After identification of localizable material and non-localizable materials in step 603, including accommodation of any tags and/or lists, the process flows to step 605, whereat the localizable and non-localizable materials that have been identified are compiled into different binary files as discussed above. In particular, the localizable materials are compiled and linked in a DLL that is separate from the binary containing compiled non-localizable materials. At step 607, the process adapts the non-localized binary to account for the separately binarized localized materials. As discussed above, this will typically require modification of links and resource loading to account for the new location.

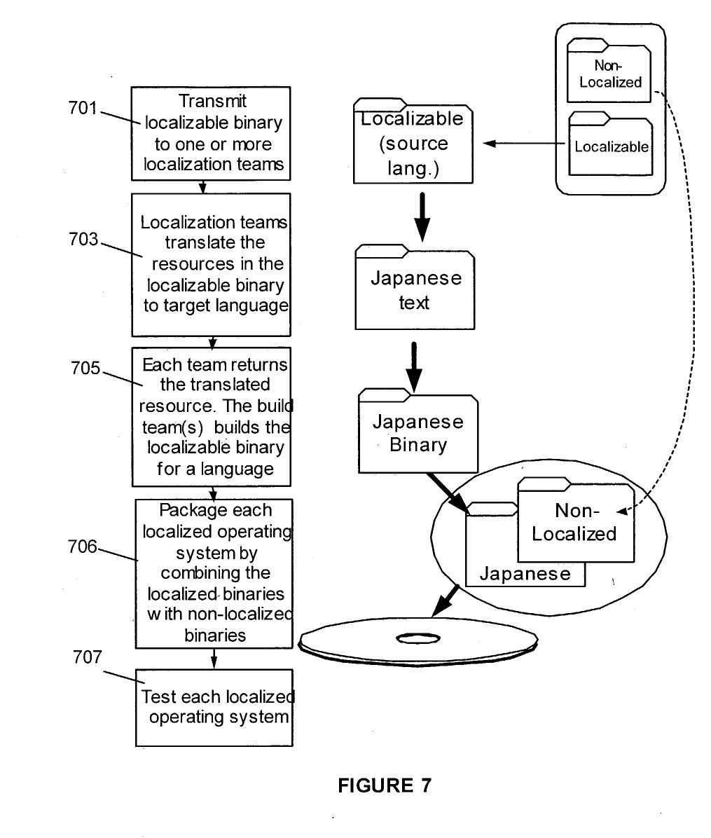

Once the separate binarization of localizable and non-localizable materials is accomplished, such as pursuant to one of the splitting techniques described above, the localization process can begin. In overview, the non-localizable binary will remain the same regardless of locale, whereas the localizable binary will be localized to account for the eventual usage context of the operating system. As such, the localization process described hereinafter focuses primarily on the localizable binary portion of the operating system. An exemplary process for localization is shown in the flow chart of FIG. 7. In particular, at step 701, the localizable binary is transmitted to one or more localization teams. The teams comprise one or more individuals who are skilled in the starting language of the localizable binary, i.e. the language used in the source code and original resources, and who are also skilled in the target language for localization. For example, to localize an operating system when the source code from the developer or developers embodied English language resources, the appropriate Japanese localization team is one that is skilled in both English and Japanese.

At step 703, each localization team translates the localizable binary to their target language and/or customs (currency, etc.) as appropriate by using a set of localization tools. In step 705, each team returns their localized data to a central build team. The build team will then create the localized binaries from the translated data. In the example of FIG. 7, this entails creation of a Japanese binary. In this manner, once this step is complete for all translation teams, the operating system files include the non-localizable binary as well as a localized binary for each target language.

At step 706, the different language(s) operating systems are packaged, such as by writing each onto a CD or other memory storage medium. In particular, preferably a localized operating system is packaged for each target language or locale, with each package including both the non-localizable binary and the appropriate localized binary. A package may include more than one localized binary, i.e. resource pack, depending upon the purchaser's needs. For example, as discussed above, it will be typical for European packages to include numerous resource packs, due to the likelihood of having users of different linguistic background in a single location.

Although the operating system may have been tested after it was compiled in its original language, each localized operating system package (i.e. the non-localizable binary combined with the appropriate localized binary) may also be tested as in step 707 to ensure proper function, and any bugs specific to one or more localized versions are preferably resolved at this stage. It will be appreciated that testing can be performed with respect to a package or initial build that includes multiple languages.

A user, such as a company, that desires to support different languages may either install a separate localized package for each end user or may install a single package supporting numerous resource packs. The choice between these options depends largely on the exact usage scenario as discussed earlier. If a single-language package is installed on each machine, the installer still needs to be mindful to install the right package on the right machine. However, significant administrative savings are accrued when such systems are updated or fixed. For example, an error, bug, security flaw, etc. that needs to be fixed after release of the operating system will typically be in the non-localized binary portion of the operating system, and in any case will likely be in one but not both of the non-localized binary and the localized binary.

If the error or flaw lies in the non-localized binary portion of the operating system, then one fix, patch, etc. can be generated (i.e. for the non-localized binary) and the same fix applied to every version of the operating system regardless of which resource pack was installed with the non-localized binary. Similarly, if the error or flaw lies in the localized binary portion of the operating system, then again one correction can be generated, i.e. only for the affected resource pack. Updates to the operating system, such as to add additional functionality even in the absence of any error or flaw, can be handled in the same manner.

As discussed above, system setup and resource loading are affected by the structure of the operating system as having separate localized and non-localized binaries, the non-localized binary being substantially language neutral. As discussed above, during the separation of a program (either a mixed binary or mixed source code) into a localizable binary (one or more files) and a non-localizable binary (one or more files), the localized portion is placed in a separate “resource” file or files, such as a DLL, with a distinct extension, such as .MUI. The system resource loader (used during operation of the system to retrieve needed resources) is modified to account for the separateness of the resource file. In particular, the resource loader is adapted to look in the separate resource binary for needed resources, and to retrieve such resources when needed. As discussed earlier, a manifest may supply a mapping to redirect resource inquiries to the appropriate location in the appropriate resource pack. Note that in an embodiment, applications running on the operating system are preferably designed to be aware of the split nature of the operating system, and as such are adapted to locate needed resources via the manifest.

System set up functions, used during installation to properly install the operating system components on the target system, must also be able to handle the separate resources. In particular, as discussed above, the operating system at any moment comprises two components (a substantially language neutral non-localized portion and a localized portion), so both need to be properly installed when the operating system is installed. Moreover, in some situations multiple resource packs are included in the OS package as delivered and some or all resource packs will be installed on the target machine. The set up function should properly install all components and should also provide a user interface that is initially in an appropriate language and that also directs the installer as to which resource pack or packs to install or to make the primary or default pack.

Although the latter choice may typically reside with the installer themselves, there are a number of ways to initially select a language for the UI aspect of the set up function. If there is only a single resource pack in the OS package, then the language used during set up preferably corresponds to the language of the resource pack. If on the other hand multiple resource packs are included, a choice of language will be made. If the installation is an upgrade from an earlier operating system, then the language used in the prior operating system is preferably also used during set up of the new operating system. If the present installation is a first installation rather than an update, then the first screen of the set up process is preferably multi-lingual and prompts the user to select a language for set up. The set up process may automatically then install the corresponding resource pack, with the user being given the option if appropriate to install additional resource packs from the OS package.

Preferably, a UI language manager control panel is provided during operation of the operating system, such as via a selectable icon or menu item, whereby the user may switch the primary language of the interface (i.e. resources are now obtained from a different resource pack) and/or install additional resource packs. The same control panel preferably also allows removal of one or more resource packs in an embodiment of the invention. However, it is preferable that the user not be able to remove all resource packs as this would typically render the operating system incomplete and inoperable since all or most user interface materials will be unavailable to the system.

It will be appreciated that an improved operating system architecture and method of producing, installing, and using the improved operating system architecture have been described. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that some elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

We claim:

1. A bifurcated operating system for controlling the operation of a computer, the bifurcated operating system comprising:
a localized binary portion, wherein the localized binary portion comprises at least a localized user interface component adapted for a target language; and
a substantially language neutral binary portion separate from the localized binary portion and comprising at least a programmatic component of the operating system and a resource loading component of the operating system adapted to load operating system resources from the localized binary portion of the operating system.

2. The bifurcated operating system according to claim 1, wherein the localized user interface component of the localized binary portion of the operating system comprises a language dependent element containing language dependent resources, the resources being substantially all consistent with the target language, the resources being selected from the group consisting of a textual representation, graphical representation, and currency representation.

3. The bifurcated operating system according to claim 1, wherein the substantially language neutral binary portion comprises a language dependent component, the language dependent component being substantially smaller than the language dependent element of the localized binary portion of the operating system.

4. The bifurcated operating system according to claim 3, wherein the language dependent component of the substantially language neutral binary portion of the bifurcated operating system comprises user interface information for display during an unintended system condition.

5. The bifurcated operating system according to claim 1, further comprising a manifest usable by the substantially language neutral binary portion of the bifurcated operating system to retrieve material from the localized binary portion of the operating system.

6. The bifurcated operating system according to claim 1, wherein the localized binary portion of the operating system further comprises a language neutral component.

7. The bifurcated operating system according to claim 6, wherein the language neutral component of the localized binary portion of the operating system comprises a language neutral driver.

8. The bifurcated operating system according to claim 1, further comprising a second localized binary portion, wherein the second localized binary portion comprises at least a localized user interface component adapted for a second target language.

9. The bifurcated operating system according to claim 8, wherein the operating system is adapted to use one of the localized binary portion and the second localized binary portion at a given time.

10. The bifurcated operating system according to claim 8, wherein the operating system is adapted to use both of the localized binary portion and the second localized binary portion at a given time, wherein user interface resources according to the localized binary portion are presented to a first user of the bifurcated operating system and user interface resources according to the second localized binary portion are presented to a second user of the bifurcated operating system.

11. The bifurcated operating system according to claim 8, wherein the operating system is adapted to select for use either the localized binary portion or the second localized binary portion at a given time, wherein the selection is based upon the identity of a user of the bifurcated operating system.

12. A computer readable medium having stored thereon computer executable instructions for installing on a computer a bifurcated operating system according to claim 1.

13. A method of making a readily localizable two-part operating system comprising:
receiving a source code representation of an operating system comprising components;
classifying each component of the operating system as either localizable or non-localizable; and
compiling operating system components classified as localizable to a first binary and operating system components classified as non-localizable to a second binary, wherein the second binary is substantially language neutral.

14. The method according to claim 13, wherein a resource loading component in the second binary is adapted to load a resource for the operating system from the first binary.

15. The method according to claim 13, wherein classifying each component of the operating system as either localizable or non-localizable comprises reading a tag associated with at least one component, wherein the tag specifies that the component is to be treated as localizable.

16. The method according to claim 13, wherein classifying each component of the operating system as either localizable or non-localizable comprises reading a tag associated with at least one component, wherein the tag specifies that the component is to be treated as non-localizable.

17. The method according to claim 13, wherein classifying each component of the operating system as either localizable or non-localizable comprises reading a list, wherein the list identifies components which are to be treated as non-localizable.

18. The method according to claim 13, wherein classifying each component of the operating system as either localizable or non-localizable comprises reading a list, wherein the list identifies components which are to be treated as localizable.

19. The method according to claim 13, wherein classifying each component of the operating system as either localizable or non-localizable comprises reading a resource manifest.

20. A computer readable medium having stored thereon computer executable instructions for performing the method according to claim 13.

21. The method according to claim 13, wherein classifying each component of the operating system as either localizable or non-localizable comprises parsing a resource manifest, and wherein compiling operating system components classified as localizable to a first binary and operating system components classified as non-localizable to a second binary comprises compiling language neutral resources and language dependent resource into different resource binaries.

22. A method of making a readily localizable two-part operating system comprising:
receiving a compiled representation of an operating system comprising portions representative of operating system components;
classifying each component as either localizable or non-localizable; and
creating a first binary portion of the operating system representative of components classified as localizable and creating a second binary portion of the operating system representative of components classified as non-localizable, wherein the second binary is substantially language neutral.

23. A computer readable medium having stored thereon computer executable instructions for performing the method according to claim 22.

24. A method of localizing an operating system having a substantially language neutral first portion and a substantially language dependent second portion to create a localized version of the operating system for a target language comprising the substantially language neutral first portion and a localized second portion corresponding to the substantially language dependent second portion, wherein the localized second portion is adapted to the target language, and wherein the language neutral first portion of the operating system requires the localized second portion in order to function, the method comprising:
localizing the substantially language dependent second portion for the target language to create the localized second portion; and
packaging the substantially language neutral first portion and the localized second portion for distribution as a localized operating system.

25. The method according to claim 24, wherein the substantially language dependent second portion corresponds to a default language, and wherein the localized second portion for the localized version of the operating system for the default language comprises the substantially language dependent second portion.

26 A computer readable medium having stored thereon computer executable instructions for performing the method according to claim 24.

27. A method of making a two-part operating system having two interdependent portions, the method comprising:
a receiving step for receiving a compiled representation of an operating system comprising portions representative of operating system components;
a classifying step for classifying each component as either localizable or non-localizable; and
a creation step for creating a first binary portion of the operating system representative of components classified as localizable and for creating a second binary portion of the operating system representative of components classified as non-localizable, wherein the second binary is substantially language neutral.

28. A method of making a readily localizable two-part operating system comprising:
a receiving step for receiving a source code representation of an operating system comprising components;
a classifying step for classifying each component of the operating system as either localizable or non-localizable; and
a compiling step for compiling operating system components classified as localizable to a first binary and operating system components classified as non-localizable to a second binary, wherein the second binary is substantially language neutral.

29. A bifurcated application operable in conjunction with a computer system, the bifurcated application comprising:
a localized binary portion, wherein the localized binary portion comprises at least a localized user interface component adapted for a target language; and
a substantially language neutral binary portion separate from the localized binary portion and comprising at least a programmatic component of the application adapted to obtain resources from the localized binary portion of the application.

30. The bifurcated application according to claim 29, wherein the localized user interface component comprises a language dependent element containing language dependent resources, the resources being substantially all consistent with the target language.

31. The bifurcated application according to claim 29, wherein the substantially language neutral binary portion comprises a language dependent component, the language dependent component being substantially smaller than the language dependent element of the localized binary portion.
